(19) United States
(12) Patent Application Publication
(10) Pub. No.: US 2011/0075338 A1
(43) Pub. Date: Mar. 31, 2011

(54) Computer

(75) Inventors: YI-CHUN TANG, Taipei (TW); HO-CHING HUANG, Taipei (TW); HUI-CHEN WANG, Taipei (TW); MEI-YIN YEH, Taipei (TW); I-TIEN HSIEH, Taipei (TW)

(73) Assignee: PEGATRON CORPORATION, Taipei (TW)

(21) Appl. No.: 12/861,879

(22) Filed: Aug. 24, 2010

(30) Foreign Application Priority Data
Sep. 25, 2009 (TW) 098132458

(51) Int. Cl. G06F 1/16

(52) U.S. Cl. 361/679.4

(57) ABSTRACT

A computer includes a casing, a carrier, a card reader, and a cover. The casing has a containing space and an opening, and the opening communicates with the containing space. The carrier is located in the containing space and is slidably connected with the casing. The card reader is disposed at the carrier. The cover is pivotally connected with the casing, and the cover has a sealing element for covering and sealing the opening.

### CROSS-REFERENCE TO RELATED APPLICATIONS

This Non-provisional application claims priority under 35 U.S.C. §119(a) on Patent Application No(s). 098132458 filed in Taiwan, Republic of China on Sep. 25, 2009, the entire contents of which are hereby incorporated by reference.

### BACKGROUND OF THE INVENTION

1. Field of the Invention

This invention relates to a computer and, more particularly, to a computer with a waterproof card reader.

2. Description of the Related Art

There are a plurality of kinds of integrated circuit (IC) cards, and a smart card is one kind of the integrated circuit cards. The smart card can allow a possessor to perform predetermined operation and can provide calculation, encryption, two-way communication, and safety functions. Thus, besides a data storing function, the smart card can also protect the stored data. A computer, such as a notebook computer, can have a built-in card reader or be externally connected with a card reader to support reading and writing a smart card or other types of the integrated circuit cards.

As far as a notebook computer with a built-in card reader is considered, a user can plug a smart card or other types of the integrated circuit cards into the card reader in the notebook computer to read data, and the integrated circuit card plugged into the card reader may be exposed from the notebook computer to facilitate plug and pull. However, as the integrated circuit card is exposed to the outside, the integrated circuit card fails to satisfy waterproof, dustproof, or anti-falling needs.

### BRIEF SUMMARY OF THE INVENTION

This invention provides a computer capable of hiding an integrated circuit card plugged into a built-in card reader and providing waterproof, dustproof, or anti-falling protection for the integrated circuit card.

This invention provides a computer including a casing, a carrier, a card reader, and a cover. The casing has a containing space and an opening, and the opening communicates with the containing space. The carrier is located in the containing space and is slidably connected with the casing. The card reader is disposed at the carrier. The cover is pivotally connected with the casing, and the cover has a sealing element for covering and sealing the opening.

According to the invention, the card reader is disposed at the carrier, and the carrier can slide relative to the casing. When a user plugs an integrated circuit card into the computer, the carrier can drive the card reader and the integrated circuit card plugged into the card reader to enter into the casing of the computer. The movable cover covers and seals the opening of the casing to provide waterproof, dustproof, or anti-falling protection for the card reader and the integrated circuit card. In addition, the user just needs to allow the carrier to slide out of the casing thus to expose the integrated circuit card plugged into the card reader from the casing, thereby plugging and pulling the integrated circuit card. Thereby, convenience and durability of the integrated circuit card in use can be achieved.

These and other features, aspects, and advantages of the present invention will become better understood with regard to the following description, appended claims, and accompanying drawings.

### BRIEF DESCRIPTION OF THE DRAWINGS

FIG. 1 is a three-dimensional diagram showing a computer according to one embodiment of the invention.

FIG. 2 is a three-dimensional diagram showing a cover exposing a containing space in FIG. 1.

FIG. 3 is a three-dimensional diagram showing a carrier sliding relative to a casing in FIG. 1.

FIG. 4 is a partial top view showing the computer in FIG. 1.

FIG. 5 is a partial top view showing the carrier sliding relative to the casing in FIG. 1.

FIG. 6 is a schematic diagram showing a card reader and a data access device sharing a connecting interface in FIG. 1.

FIG. 7 is a partial three-dimensional diagram showing the computer in FIG. 1.

FIG. 8 is a partial top view showing a computer according to another embodiment of the invention.

FIG. 9 is a partial top view showing a carrier sliding relative to a casing in FIG. 8.

### DETAILED DESCRIPTION OF THE INVENTION

Via a structural design and improvement, a computer in this invention can allow an integrated circuit card to have convenience and durability in use together. The computer can be a notebook computer, a desktop computer, or other electronic devices with a card reader. In the following embodiment, a notebook computer is taken for example.

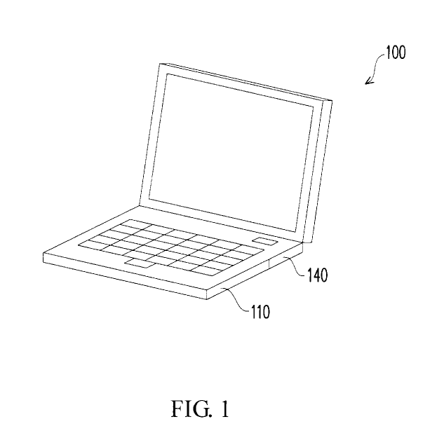

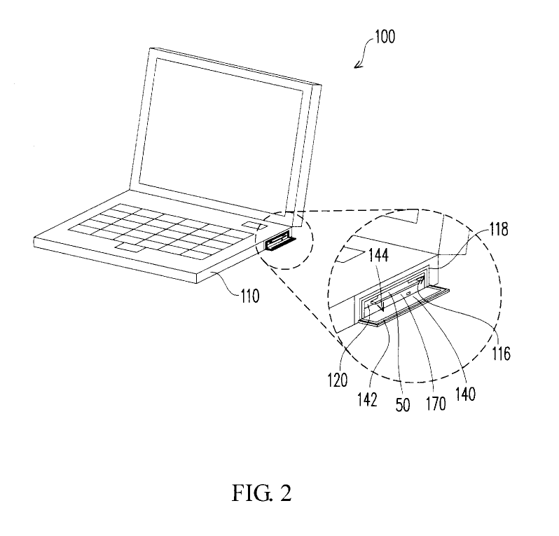

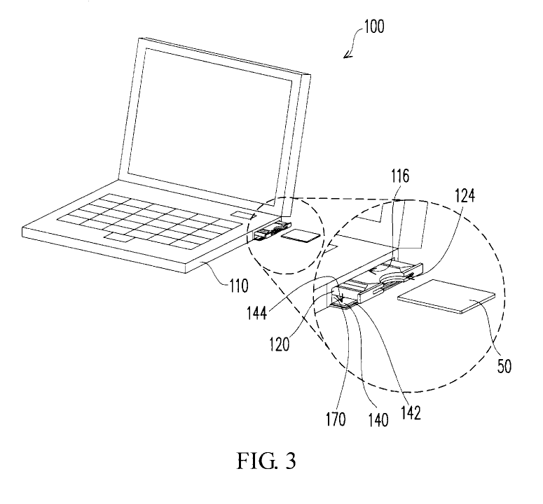

FIG. 1 is a three-dimensional diagram showing a computer according to one embodiment of the invention. FIG. 2 is a three-dimensional diagram showing a cover exposing a containing space in FIG. 1. FIG. 3 is a three-dimensional diagram showing a carrier sliding relative to a casing in FIG. 1. In FIG. 1 and FIG. 2, in the embodiment, a computer 100 may be a notebook computer and is used for reading an integrated circuit card 50. The integrated circuit card 50 may be a smart card or other types of cards.

The computer 100 includes a casing 110, a carrier 120, and a cover 140. When the carrier 120 is located in the casing 110, the cover 140 can cover the integrated circuit card 50. In the embodiment, the carrier 120 in a state as shown in FIG. 2 can be partly moved from the casing 110 to be in a state as shown in FIG. 3 thus to facilitate plugging and pulling the integrated circuit card 50.

The cover 140 has a sealing element 142, and the casing 110 has a protrudent portion 118. The sealing element 142 is disposed at an edge of a surface 144 of the cover 140 facing the casing 110. The protrudent portion 118 surrounds an opening 116 and the location of the protrudent portion 118 corresponds to the location of the sealing element 142. When the cover 140 covers the casing 110 (as shown in FIG. 1), the protrudent portion 118 can be against the sealing element 142 to achieve a waterproof and dustproof effect. The sealing element 142 may be made of rubber, thereby allowing the cover 140 to totally seal a containing space via elastic deformation of the sealing element 142.

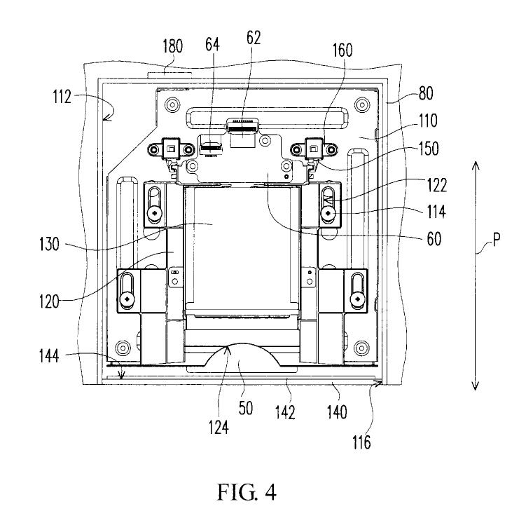

FIG. 4 is a partial top view showing the computer in FIG. 1. In FIG. 4, in the embodiment, the computer 100 further includes a card reader 130 disposed at the carrier 120. The casing 110 has a containing space 112 and an opening 116, and the opening 116 communicates with the containing space 112. The carrier 120 is located in the containing space 112 and is slidably connected with the casing 110. The cover 140 is pivotally connected with the casing 110 and has a sealing element 142 for covering and sealing the opening 116.

In detail, the carrier 120 is slidably disposed in the containing space 112 to slide along a sliding path P relative to the casing 110. The cover 140 is disposed at the opening 116 to seal or expose the containing space 112. The card reader 130 is disposed on the carrier 120 and located in the containing space 112, and the integrated circuit card 50 is suitable for being plugged into the card reader 130. In FIG. 4, when the carrier 120 is located at one end of the sliding path P, the integrated circuit card 50 plugged into the card reader 130 is located in the containing space 112. At that moment, a user can operate the cover 140 to seal the containing space 112 to protect the integrated circuit card 50 located in the containing space 112, thereby achieving a waterproof, dustproof, and anti-falling effect.

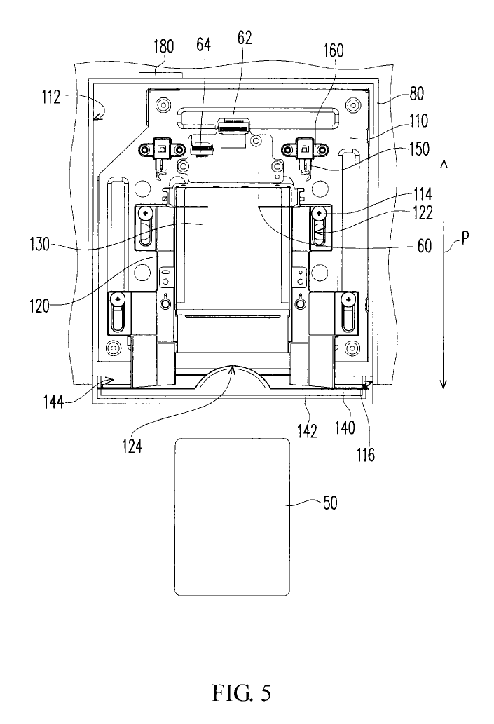

FIG. 5 is a partial top view showing the carrier 120 sliding relative to the casing 110 in FIG. 1. When the user is to pull the integrated circuit card 50 from the card reader 130, the user can first open the cover 140 to expose the containing space 112 and then make the carrier 120 sliding to a position as shown in FIG. 5 thus to be located at the other end of the sliding path P. At that moment, the user can pull the integrated circuit card 50 from the card reader 130 (the integrated circuit card 50 is pulled out in FIG. 5). In addition, the user can plug the integrated circuit card 50 into the card reader 130 when the carrier 120 is located in a position as shown in FIG. 5, and then the user can make the carrier 120 sliding to the position in FIG. 4 along the sliding path P (that is, the card reader 130 also slides along the sliding path P) and cover the cover 140 to seal the containing space 112. In FIG. 4, the carrier 120 in the embodiment has an integrated circuit card guiding groove 124 (also shown in FIG. 3), and the integrated circuit card guiding groove 124 extends from one end of the card reader 130 towards the opening 116 to the opening 116 for guiding the integrated circuit card 50 in moving towards the casing 110 further to be plugged into the card reader 130.

In the embodiment, the computer 100 further includes a push-push mechanism 150 (two push-push mechanisms are shown) disposed in the containing space 112 and connected between the carrier 120 and the casing 110 to drive the carrier 120 to slide along the sliding path P. In detail, the push-push mechanisms 150 and the carrier 120 can form interference to allow the carrier 120 to be fastened to the position in FIG. 4 thus to be located in the containing space 112. The user can push the carrier 120 to press the push-push mechanisms 150 thus to drive the push-push mechanisms 150 to release the carrier 120 and to exert push force on the carrier 120, thereby allowing the carrier 120 to be flipped from the containing space 112 to the position as shown in FIG. 5 along the sliding path P to partly move out of the containing space 112.

In addition, the user can push the carrier 120 in FIG. 5 into the containing space 112 along the sliding path P to press the push-push mechanisms 150, thus allowing the push-push mechanisms 150 and the carrier 120 to form interference to fasten the carrier 120 to the position as shown in FIG. 4. In the embodiment, the computer 100 further includes a fastening element 160 (two fastening elements are shown) for fastening the push-push mechanisms 150 to the casing 110.

In the embodiment, the carrier 120 has a plurality of sliding grooves 122 (four sliding grooves are shown), and the casing 110 has a plurality of guiding pins 114 (four guiding pins are shown). The sliding grooves 122 extend along the sliding path P, and the guiding pins 114 are located in the sliding grooves 122, respectively, to allow the carrier 120 to be slidably disposed at the casing 110. The carrier 120 can slide relative to the casing 110 via the relative displacement between the guiding pins 114 and the sliding grooves 122 along the sliding path P.

In FIG. 2, in the embodiment, the computer 100 further includes a data access device 170. The data access device 170 is stacked on the carrier 120 and disposed in the containing space 112 together with the carrier 120, and the opening 116 exposes the carrier 120 and the data access device 170.

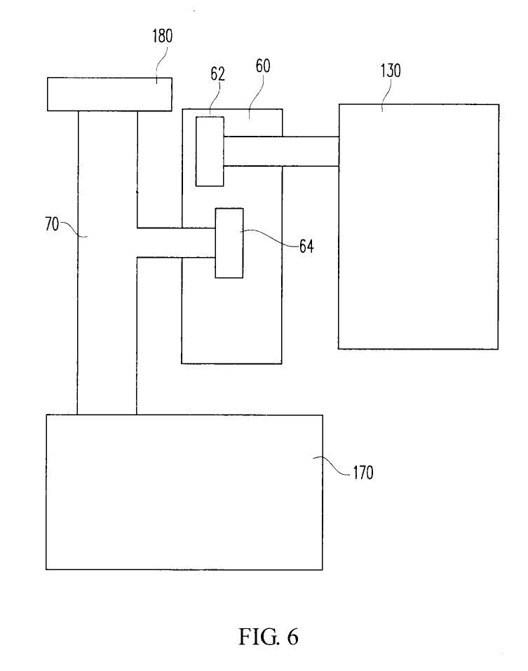

FIG. 6 is a schematic diagram showing the card reader 130 and the data access device 170 sharing a connecting interface in FIG. 1. In FIG. 4 and FIG. 6, in the embodiment, the computer 100 further includes a connecting interface 180. The data access device 170 and the card reader 130 disposed on the carrier 120 share the connecting interface 180 to be electrically connected with a motherboard (not shown) of the computer 100.

In detail, the data access device 170 is connected with the connecting interface 180 via a flexible printed circuit (FPC) 70. The card reader 130 is connected with a connecting terminal 62 of a daughter board 60, and a connecting terminal 64 of the daughter board 60 is connected with the connecting interface 180 via the flexible printed circuit 70, thus allowing the data access device 170 and the card reader 130 to share the connecting interface 180.

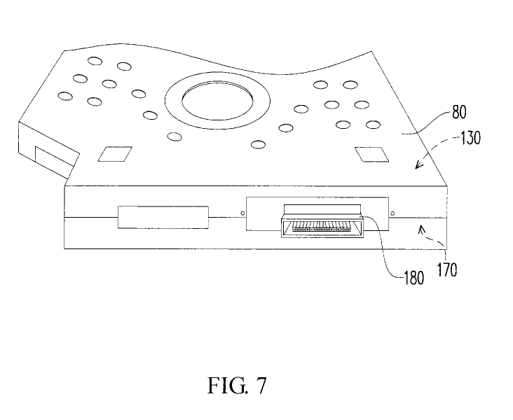

In other words, the card reader 130 can be designed to share the containing space 112, the connecting interface 180, and the cover 140 with the data access device 170 to save the disposition space of the computer 100. In the embodiment, the data access device 170 may be an optical disc drive or other data access devices disposed in a notebook computer. FIG. 7 is a partial three-dimensional diagram showing the computer in FIG. 1. In FIG. 7, in the embodiment, the data access device 170 and the card reader 130 can be covered by an internal casing 80 of the casing 110 (as shown in FIG. 4), and the connecting interface 180 is exposed from the internal casing 80 to be electrically connected with the motherboard of the computer 100.

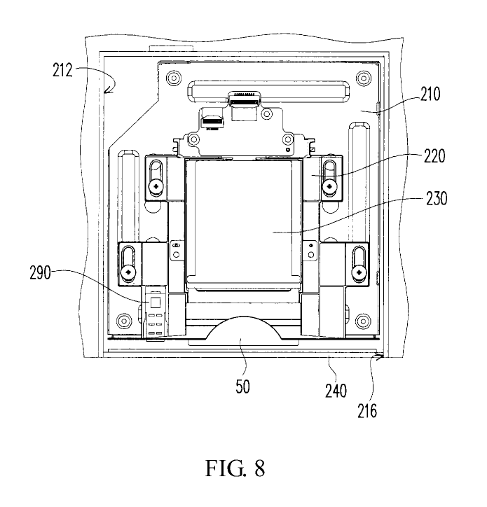

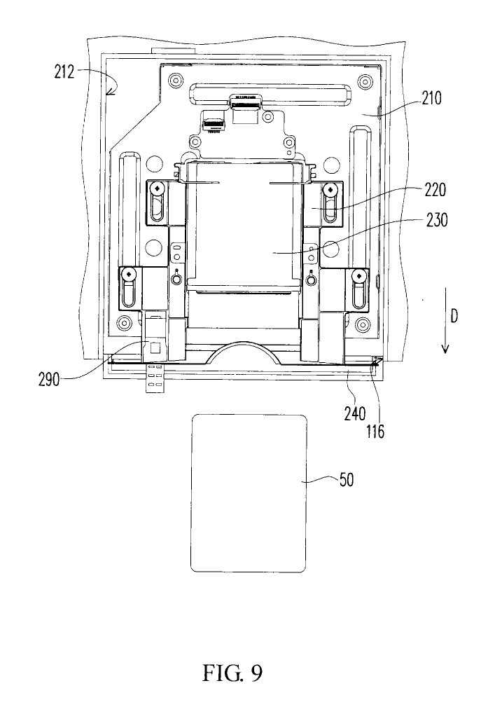

FIG. 8 is a partial top view showing a computer according to another embodiment of the invention. FIG. 9 is a partial top view showing a carrier sliding relative to a casing in FIG. 8. In FIG. 8, compared with the carrier 120 in FIG. 4 and FIG. 5 which slides relative to the casing 110 via the drive of the push-push mechanisms 150, in this embodiment, a carrier 220 slides relative to a casing 210 via drive of a string 290. In detail, the string 290 is slidably disposed at the carrier 220 and is located at one side of the carrier 220 towards an opening 216. When the carrier 220 is located in a containing space 212 and a cover 240 is covered, the string 290 is located in the containing space 212. In FIG. 9, after the user opens the cover 240 and pulls the string 290 from the carrier 220, he or she continuously pulls the string 290 along a direction D to drive the carrier 220 to partly move out of the containing space 212, thereby facilitating plugging or pulling an integrated circuit card 50 from a card reader 230 by the user (the integrated circuit card 50 is pulled out as shown in FIG. 9).

To sum up, according to the embodiments of the invention, the card reader is disposed on the carrier, and the carrier can slide relative to the casing. When the user plugs the integrated circuit card into the computer, the carrier can drive the card reader and the integrated circuit card plugged into the card reader to enter into the casing of the computer. The movable cover can cover and seal the opening of the casing to provide waterproof, dustproof, or anti-falling protection for the card reader and the integrated circuit card. In addition, when the user is to plug or pull the integrated circuit card, he or she just needs to allow the carrier to slide out of the casing to expose the integrated circuit card plugged into the card reader from the casing, thereby being capable of plugging or pulling the integrated circuit card. Thereby, convenience and durability of the integrated circuit card in use can be achieved at the same time. In addition, the disk drive or other data access devices in the computer and the carrier can be disposed in one containing space, thus allowing the disk drive or other data access devices and the card reader to share the containing space, the connecting interface, and the cover to save disposition space of the computer.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A computer comprising:
a casing having a containing space and an opening, the opening communicating with the containing space;
a carrier located in the containing space and slidably connected with the casing;
a card reader disposed at the carrier; and
a cover pivotally connected with the casing, the cover having a sealing element for covering and sealing the opening.

2. The computer according to claim 1, further comprising a string disposed at the carrier and located at one side of the carrier towards the opening.

3. The computer according to claim 1, further comprising a push-push mechanism disposed in the containing space and connected between the carrier and the casing.

4. The computer according to claim 3, further comprising a fastening element, wherein the push-push mechanism is fastened to the casing via the fastening element.

5. The computer according to claim 1, wherein the casing has a protrudent portion surrounding the opening and the location of the protrudent portion corresponds to the location of the sealing element.

6. The computer according to claim 1, wherein the carrier has a plurality of sliding grooves, the casing has a plurality of guiding pins, and the guiding pins are located in the sliding grooves, respectively.

7. The computer according to claim 1, further comprising a data access device stacked on the carrier and disposed in the containing space, the opening exposing the carrier and the data access device.

8. The computer according to claim 7, further comprising a connecting interface, wherein the card reader and the data access device are connected with the connecting interface.

9. The computer according to claim 1, wherein the carrier has an integrated circuit (IC) card guiding groove extending from one end of the card reader towards the opening to the opening.
